(19) United States
(12) Patent Application Publication
(10) Pub. No.: US 2013/0139923 A1
(43) Pub. Date: Jun. 6, 2013

(54) ABOVE-GROUND REMOVABLE WATER PIPING INSULATION APPARATUS

(71) Applicant: EDWARD STOKELY, Green Spring Cove, FL (US)

(72) Inventor: EDWARD STOKELY, Green Spring Cove, FL (US)

(21) Appl. No.: 13/310,224

(22) Filed: Dec. 2, 2011

(51) Int. Cl. F16L 55/00

(52) U.S. Cl. 138/103

(57) ABSTRACT

A thermal cover for a backflow prevention assembly is disclosed. The thermal cover includes a first and second insulated tube each to cover piping components of the backflow prevention assembly an insulated box cover configured to house water control components of the backflow prevention assembly. A first end on each of the insulated tubes is receivable by an insulated box cover and a second end is configured to abut a ground surface. The insulated box cover is sealed using removable fastening means to enable access to the water control components.

### TECHNICAL FIELD

This disclosure relates to water piping, and more particularly to insulation of water pipes and flow control devices.

### BACKGROUND

The statements in this section merely provide background information related to the present disclosure and may not constitute prior art.

For certain water supply systems, governmental codes or ordinances typically require, at the user site, a backflow preventer at the connection from the utility supply to the user's system. The purpose is to prevent flow of contaminated water backward from the user system into the potable water system of the utility due to back-siphoning conditions.

One type of backflow prevention apparatus widely used in commercial and residential irrigation systems is a reduce pressure assembly (RPA) and double-check valve assembly (DVA) mounted above ground proximate to the water meter and between the water outlet from the meter and the inlet to the water system. During the fall of the year, when ambient temperatures are dropping, sharp drops in ambient temperature below the freezing mark place the components at risk for cracks and other damage. Ground temperatures remains above freezing so there is less danger of water freezing in the underground pipes. However, the backflow preventer valve assembly and the pipes leading to and from it are above ground and thus susceptible to freezing and associated damage.

Various insulating devices and methods to prevent freezing pipes and hose bibs have been devised including bags, sleeves, and taping methods. Known devices and methods require regular maintenance and replacement. Therefore, it would be advantageous to provide a durable device for reducing the risk of freezing of water in backflow prevention apparatus and water control devices subjected to transient below-freezing ambient temperatures.

### SUMMARY

An apparatus is disclosed for insulating water piping and water control devices above ground.

A thermal cover for a backflow prevention assembly is disclosed. The thermal cover includes a first and second insulated tube each to cover piping components of the backflow prevention assembly an insulated box cover configured to house water control components of the backflow prevention assembly. A first end on each of the insulated tubes is receivable by an insulated box cover and a second end is configured to abut a ground surface. The insulated box cover is sealed using removable fastening means to enable access to the water control components.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows a backflow prevention assembly and, in cross section, an insulation apparatus, in accordance with the present disclosure;

FIG. 2 is a perspective view of a box cover of the insulation apparatus, in accordance with the present disclosure;

FIG. 3 is a perspective view of the box cover in an open state, in accordance with the present disclosure;

FIG. 4 is a bottom view of the box cover, in accordance with the present disclosure; and

FIG. 5 is a perspective view of an insulation tube of the insulation apparatus, in accordance with the present disclosure.

### DETAILED DESCRIPTION

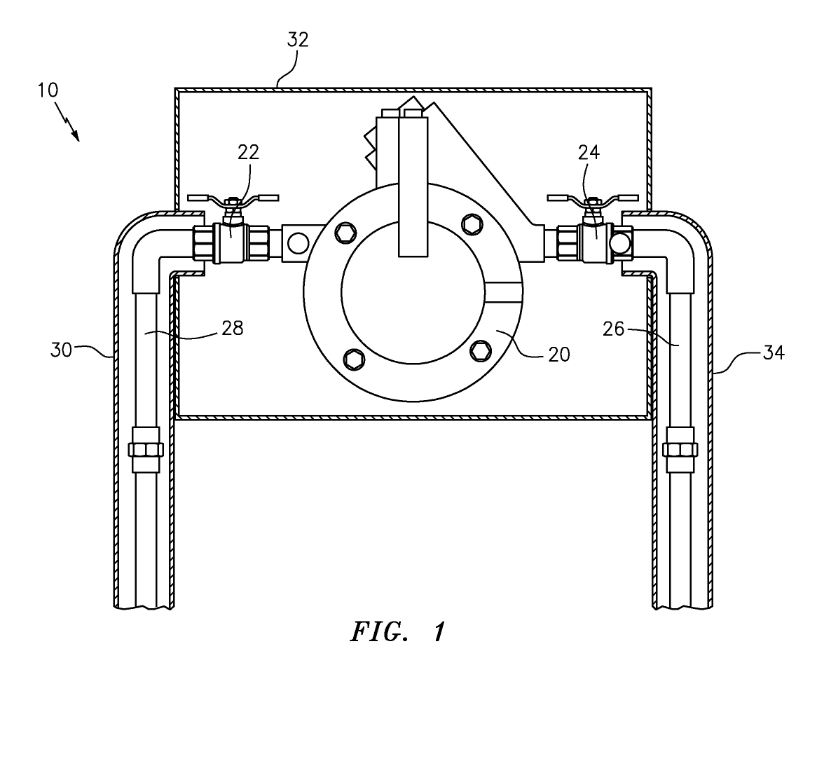

Referring now to the drawings, wherein the depictions are for the purpose of illustrating certain exemplary embodiments only and not for the purpose of limiting the same, FIG. 1 schematically shows an insulation apparatus 10 covering various liquid flow devices and pipes including a backflow prevention assembly 20, connecting pipes 26 and 28, and flow control devices 22 and 24. The insulation apparatus 10 includes an insulated box cover 32 and a first and second insulated tube 30 and 34, respectively. The insulation apparatus 10 may be adapted to cover and insulate any number of above ground flow devices and connecting pipes including the devices shown and described herein and is therefore not intended to be limited thereby to the particular arrangement or function of the flow devices. An above-ground water backflow prevention assembly 20 is shown and described as an exemplary application of the insulation apparatus.

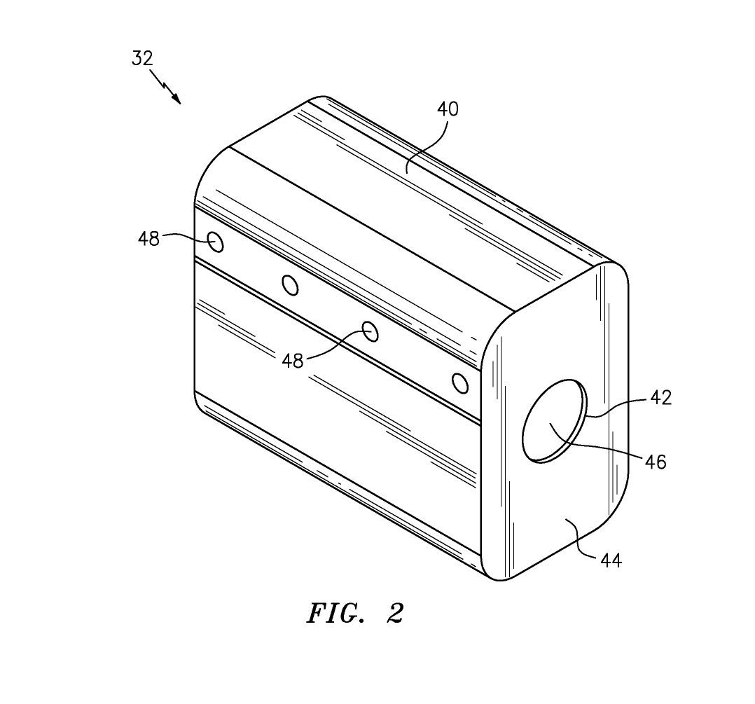

FIG. 2 shows the box cover 32 from a perspective view. The box cover 32 is shown in a closed state, i.e., a state configured to cover and insulate the water backflow prevention assembly 20. The box cover 32 includes a housing 40 configured to contain water flow devices and pipe. The thickness and material of the housing can be selected to provide the desired flexibility or rigidity for a particular application. In one embodiment, the housing 40 may be formed of a variety of materials such as, but not limited to, plastic (e.g, polypropylene, copolymer of polypropylene, polyethylene, resin materials, etc.), polyvinyl chloride (PVC), postchlorinated polyvinyl chloride (CPVC), metal, ceramic materials, composite materials (fiber glass and resin materials, carbon fibers and resin materials, etc.), resin material, or a combination of one or more of these materials. The housing is preferably insulated with an insulation liner coupled to an inner portion of the housing 40. The thickness and material of the insulation liner may vary based upon desired thermal resistance and insulation. The insulation liner may be any known type of thermal resistant material or thermal padding configured to hold and retain thermal energy within the box cover 32. In one embodiment, the thermal resistant material is formed with polyvinyl chloride polymer material such as used in Armaflex™ or Ensolite® thermal material manufactured by Armacell LLC.

The box cover 32 additionally includes a first tube-receiving-side 44 and second tube-receiving-side. Each tube-receiving-side includes an opening 46 configured to receive an insulated tube such as the first and second insulated tubes 30 and 34. The first and second tube-receiving-sides may be contiguously connected to the housing or coupled using known mechanical fastening methods. Similarly to the housing 40, the first and second sides preferably include an insulation liner 42 coupled to the inner portion of the sides. Each tube-receiving-side is additionally configured to close around the respective tubes, thereby sealing water flow pipes and water control devices from outside ambient conditions and holding internal thermal energy within the box cover 32. The openings may include additional sealing material such as a flexible rubber or polymer-based tube configured to press up against one of the first and second tubes 30 and 34. In this way, ambient conditions may be sealed from flowing within the box cover 34.

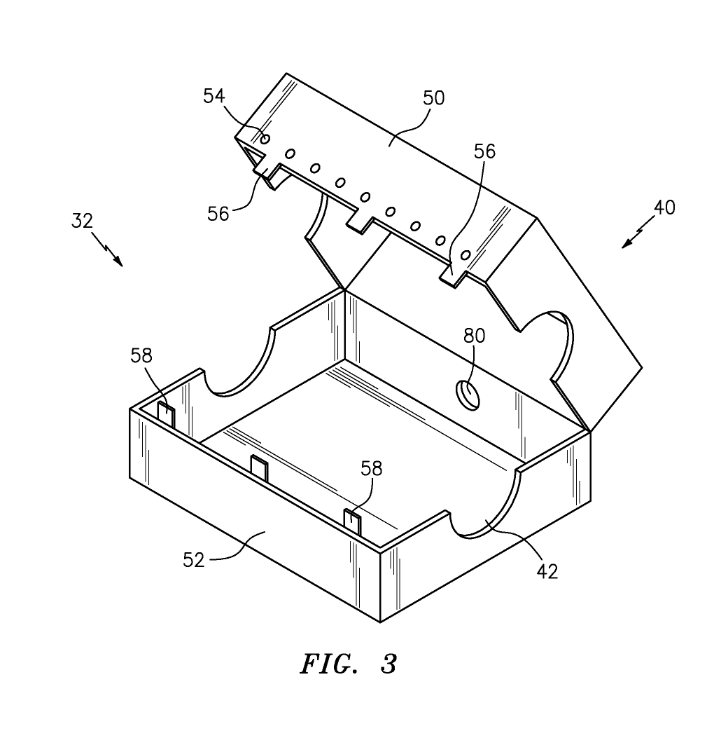

FIG. 3 shows the box cover 32 in an opened state, configured to accept the backflow prevention assembly 20. The box cover 32 is configured to open and close to be readily removable from the backflow prevention assembly 20 enabling easy access to water flow control components. The box cover 32 is preferably secured at two overlapping lids of the housing 40. As shown in FIG. 3, a first lid 50 is configured to overlap a second lid 52 when closed. The first and second lids are preferably secured together using one or more known removable mechanical fastening means such as using a nut and bolt assembly, tapered screws, tacks, staples, stitching, metal clips, snaps, clamps, and/or an elastomeric semi-compressible layer and a thin outer layer of Velcro® (hook and loop) rivets.

In one embodiment, various adhesives may be used such as glue or adhesive tape to secure the first and second lids together. The adhesive tape can have the top and/or bottom surface include an adhesive contact surface. When the adhesive tape has two adhesive sides, the type of adhesive on the two sides can be the same or different. The type of adhesive used on the adhesive tape is non-limiting. Generally, the adhesive used on the adhesive tape is a contact adhesive that forms a bond when pressed to a surface. The adhesive tape may be affixed to the first and second lids 50 and 52. In one embodiment, the first lid 50 includes members 56 configured to engage, e.g., latch, receiving members 58 on the second lid 52 enabling the box cover 32 to be readily latched or snapped into and/or removed from the water control components. In one embodiment, the first lid 50 includes a plurality of recesses 54 for receiving fixing devices, such as screws or tacks for securing the first lid 50 to the second lid 52.

The box cover 32 may additionally be formed to include an opening 80 enabling access to internal water components and release of any water build-up. The opening 80 is preferably located on a bottom portion of the box cover 32 to enable any water build-up to be readily released.

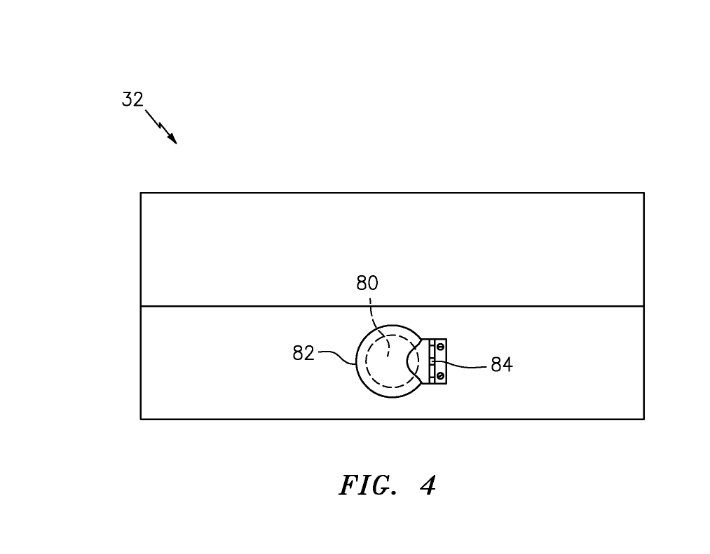

FIG. 4 shows a bottom view of the box cover 32 depicting a cover 82 over the opening illustrated in FIG. 3. The opening is preferably covered using any known plug or sealable cover structure configured to insulate when in a closed position. As FIG. 4 shows, a cover 82 may be secured to the box cover 32 using a latch mechanism 84. In one embodiment, the box cover 32 includes a drain opening formed therein that is configured to receive a drain plug for manual release of fluid.

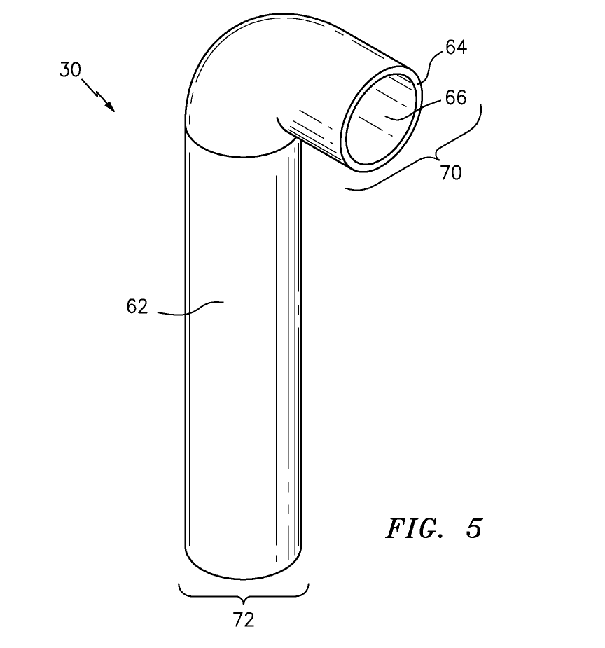

FIG. 5 shows an exemplary embodiment of the insulation tube 30. One skilled in the art will readily discern that the teachings of the insulation tube 30 are applicable to the insulation tube 34 described herein above. The insulation tube 30 includes an outer shell 62 configured to shape around an above-ground piping component such as illustrated in FIG. 1. An opening 66 is defined by the thickness and material of the outer shell 62 and an insulation liner 64 described below. A first end 70 is receivable by the insulated box cover 32 within the opening 46 as described herein above. A second end 72 is configured to abut a ground surface, preventing ambient temperature conditions from permeating into the backflow prevention assembly 20.

The outer shell 62 may be formed of a variety of materials such as, but not limited to, plastic (e.g, polypropylene, copolymer of polypropylene, polyethylene, resin materials, etc.), polyvinyl chloride (PVC), postchlorinated polyvinyl chloride (CPVC), metal, ceramic materials, composite materials (fiber glass and resin materials, carbon fibers and resin materials, etc.), resin material, or a combination of one or more of these materials. The outer shell 62 is preferably insulated with the insulation liner 64 coupled to an inner portion of the outer shell 62. The thickness and material of the insulation liner may vary based upon desired thermal resistance and insulation. The insulation liner may be any known type of thermal resistant material or thermal padding configured to hold and retain thermal energy within the insulation tube 30, protecting the piping components from outside ambient conditions.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A cover for a backflow prevention assembly, the cover comprising:
a first and second insulated tube each configured to cover a piping component of the backflow prevention assembly, wherein a first end on each of the insulated tubes is receivable by an insulated box cover and a second end is configured to abut a ground surface; and
an insulated box cover configured to house water control components of the backflow prevention assembly, wherein the insulated box cover is sealed using removable fastening means.

2. The cover of claim 1, wherein the insulated box cover comprise a housing layer and an insulation layer.

3. The cover of claim 2, wherein the housing layer is formed of a polyvinyl chloride material.

4. The cover of claim 2, wherein the insulation layer is formed of a polyvinyl chloride material.

5. The cover of claim 1, wherein the first and second insulated tubes comprise a housing layer and an insulation layer.

6. The cover of claim 5, wherein the housing layer is formed of a polyvinyl chloride material.

7. The cover of claim 5, wherein the insulation layer is formed of a polyvinyl chloride material.

8. The cover of claim 1, wherein the removable fastening means comprises a plurality of tacks.

9. The cover of claim 1, wherein the insulated box cover is configured to receive each of the first and second insulated tubes via openings, each opening configured to seal the box cover to a corresponding insulated tube.

10. A thermal cover configured to thermally insulate a water backflow prevention apparatus, the thermal cover comprising:
a first and second insulated tube each configured to cover a piping component of the backflow prevention assembly, wherein a first end on each of the insulated tubes is receivable by an insulated box cover and a second end is configured to abut a ground surface;
a first and second tube-receiving-sides contiguously connected to a housing configured to internally contain water control components of the backflow prevention assembly, wherein the housing comprises first and second overlapping lids.

11. The thermal cover of claim 10, wherein the housing is secured at the first and second overlapping lids using removable fastening means.

12. The thermal cover of claim 10, wherein the first and second tube-receiving-sides and the housing comprise a housing layer and an insulation layer.

13. The thermal cover of claim 12, the housing layer is formed of a polyvinyl chloride material.

14. The thermal cover of claim 12, wherein the insulation layer is formed of a polyvinyl chloride material.

15. The thermal cover of claim 11, wherein the removable fastening means comprises a plurality of tacks.

16. The thermal cover of claim 10, wherein the first and second insulated tubes comprise a housing layer and an insulation layer.

17. The thermal cover of claim 16, wherein the housing layer is formed of a polyvinyl chloride material.

18. The thermal cover of claim 16, wherein the insulation layer is formed of a polyvinyl chloride material.

19. The thermal cover of claim 10, wherein the insulated box cover is configured to receive each of the first and second insulated tubes via openings, each opening configured to seal the box cover to a corresponding insulated tube.

20. A method of covering a water backflow prevention apparatus and comprising the steps of:
installing an insulated tube formed of polyvinyl chloride material and insulated with polyvinyl chloride polymer around piping components of the water backflow prevention apparatus;
conforming a bottom end of the insulated tubes to a ground surface;
covering the water backflow prevention apparatus with a removable box cover and insulated with polyvinyl chloride polymer;
sealing the insulated tube to the removable box cover; and.
securing the removable box together with tacks.
